(19) United States
(12) Patent Application Publication
(10) Pub. No.: US 2014/0041541 A1
(43) Pub. Date: Feb. 13, 2014

(54) POSITIVE WORKING LITHOGRAPHIC PRINTING PLATE PRECURSOR AND A METHOD FOR MAKING A PRINTING PLATE

(71) Applicant: Yasushi Miyamoto, Tatebayashi (JP)

(72) Inventor: Yasushi Miyamoto, Tatebayashi (JP)

(21) Appl. No.: 13/982,309

(22) PCT Filed: Feb. 16, 2012
(86) PCT No.: PCT/JP2012/053696

§ 371 Date: Jul. 29, 2013

(30) Foreign Application Priority Data
Mar. 18, 2011 (JP) 2011-060090

(51) Int. Cl. B41C 1/10

(52) U.S. Cl. CPC B41C 1/1016
USPC 101/462; 101/463.1

(57) ABSTRACT

The present invention provides a CTP positive lithographic printing original plate which has satisfactory image contrast even after baking.

Disclosed is a positive lithographic printing original plate, including a substrate, and an image forming layer containing a water-insoluble and alkali-soluble resin and a photo-thermal conversion material, formed on the substrate, wherein the image forming layer contains an acid dye as a colorant.

### TECHNICAL FIELD

The present invention relates to a lithographic printing original plate, and a plate-making method thereof, and particularly to an infrared-sensitive or thermo-sensitive lithographic printing original plate which is used as a so-called CTP (computer to plate) plate capable of directly forming an image by irradiating with infrared rays from a solid laser or a semiconductor laser based on digital signals, especially a positive lithographic printing original plate.

### BACKGROUND ART

As a lithographic printing original plate, for example, a lithographic printing original plate (PS plate) comprising a photosensitive image forming layer has hitherto been known. The PS plate basically includes two kinds of a negative plate and a positive plate. When a negative plate is used, a negative film is exposed and developed, and then an image recording layer in the unexposed portion is removed, the portion insolubilized by exposure remains as an image. When a positive plate is used, a positive film is exposed and developed, and then an image recording layer in the exposed portion solubilized by exposure is removed, the unexposed portion remains as an image.

With the progress of computer image processing technology, an intense interest has been shown towards a CTP system in which an image is directly formed on an image forming layer by light irradiation corresponding to digital signals without forming an image through a film. A CTP system using high power lasers having maximum strength in a near infrared or infrared region as a light source for light irradiation has various advantages. For example, a high resolution image can be produced with a short period of exposure, and a photosensitive lithographic printing plate material used for this method can be handled in a lighted room.

In general, in a positive lithographic printing original plate, the exposed portion of an image forming layer is removed by a developing treatment, and thus exposing an aluminum substrate. Usually, a colorant is added in the image forming layer so as to easily discriminate whether or not an image is formed (so as to impart contrast). However, when the positive lithographic printing plate subjected to exposure and development is subsequently subjected to a high-temperature heat treatment (also referred to as baking or burning) for the purpose of improving press life, heat may sometimes caused fading of the added colorant, and thus decreasing image density, resulting in poor image contrast.

When an image forming layer contains a resin having a phenolic hydroxyl group, such as a novolac resin, since baking causes a change in color of the novolac resin per se, a problem such as a decrease in image contrast is less likely to occur. However, when a resin having no phenolic hydroxyl group is used, since baking does no cause a change in color of the resin, it was indispensable to add a colorant to an image forming layer.

A problem such as a decrease in density of an image formed on an aluminum substrate leads to a decrease in density of register mark serving as a mark of registering in multicolor printing, and thus placing obstacles on presswork. Therefore, there is required a colorant which provides satisfactory image contrast even after baking.

### DISCLOSURE OF THE INVENTION

### Problems to be Solved by the Invention

An object of the present invention is to provide a CTP positive lithographic printing original plate which has satisfactory image contrast even after baking.

### Means for Solving the Problems

The present inventors have intensively studied and found that the above object can be achieved by adding, as a colorant, an acid dye in an image forming layer of a positive lithographic printing original plate, and thus completing the present invention.

The present invention provides a positive lithographic printing original plate, including a substrate, and an image forming layer containing a water-insoluble and alkali-soluble resin and a photo-thermal conversion material, formed on the substrate, wherein the image forming layer contains an acid dye as a colorant.

The present invention also provides a positive lithographic printing original plate, including a substrate, and an image forming layer comprising of a lower layer containing a water-insoluble and alkali-soluble resin and an upper layer containing a water-insoluble and alkali-soluble resin, formed on the substrate, the lower layer and/or the upper layer containing a photo-thermal conversion material, wherein the lower layer and/or the upper layer contain(s) an acid dye as a colorant.

The present invention also provides a method for making a positive lithographic printing original plate, which includes imagewise exposing the above positive lithographic printing original plate according to the present invention; developing the exposed plate with a developing solution; and baking the plate.

### Effects of the Invention

The positive lithographic printing original plate of the present invention has satisfactory image contrast even after baking. In particular, satisfactory image contrast is provided in a positive lithographic printing original plate in which a resin having no phenolic hydroxyl group is used.

### Mode for Carrying Out the Invention

It is indispensable for the positive lithographic printing original plate of the present invention to use an acid dye as a colorant of an image forming layer so as to visualize an image area upon development and during printing. The “acid dye” as used herein means a dye which is a salt of color acid having an acidic group and is negatively charged when dissolved in water. Examples of the acidic group include a sulfonic acid group or a carboxyl group. The acid dye used as a colorant in the positive lithographic printing original plate of the present invention is an acid dye which does not substantially have an action of converting electromagnetic wave into thermal energy, unlike the below-mentioned “photo-thermal conversion material”.

It is possible to use, as the acid dye which can be used to color the positive lithographic printing original plate of the present invention, known acid dyes disclosed in the item of Acid Dye in “Senryou Binran” (Dye Manual), edited by the Organic Synthesis Chemistry Association, 1970, p. 393-526. Examples of the acid dye of the present invention include dyes having xanthene-based, indigoid-based, triphenylmethane-based, anthraquinone-based, azo-based, cyanine-based, and phthalocyanine-based structures.

The acid dye, which can be used in the present invention, is preferably a monobasic acid dye having a carboxylate moiety or a sulfonate moiety, and particularly preferably a xanthene-based dye, and specific examples thereof include Acid Red 52, Acid Red 87, Acid Red 91, Acid Red 92, Acid Red 94, and Erythrosine B (Acid Red 51).

Structural formulas of these preferred dyes are shown below.

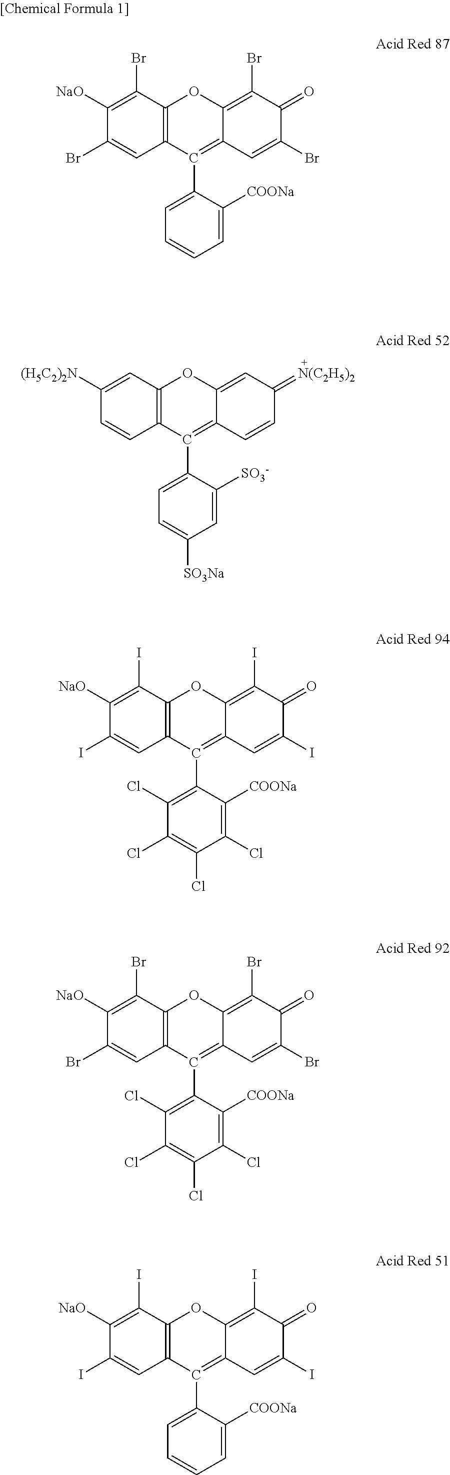

The amount of the acid dye used to color the positive lithographic printing original plate of the present invention can be within a range from 0.05 to 10% by mass based on the total mass of the image forming layer, so as to obtain satisfactory image contrast upon development and after baking. It is not preferred that the amount of the acid dye is less than 0.05% by mass of that of the image forming layer since image contrast may become poor after baking. It is not preferred that the amount of the acid dye is more than 10% by mass since press life may deteriorate. The amount of the acid dye is particularly preferably from 0.1 to 5% by mass.

As described below, even when the image forming layer has a two-layer structure comprising of a lower layer and an upper layer, the amount of the acid dye can be within a range from 0.05 to 10% by mass in terms of the total amount of the acid dye in the lower and upper layers. The acid dye according to the present invention can be used in either the lower or upper layer, or both the lower and upper layers of the image forming layer. The total amount of the acid dye in the lower and upper layers is particularly preferably from 0.1 to 5% by mass.

In the present invention, it is indispensable to use the acid dye as a colorant, and a basic dye can also be used in combination. The basic dye is more likely to lose color by baking, but provides satisfactory visibility of an image until a lithographic printing plate with an image formed thereon is baked after development.

Specific examples of the basic dye, which can be used in combination with the acid dye in the present invention, include basic dyes such as Oil Yellow #101, Oil Yellow #103, Oil Pink #312, Oil Green BG, Oil Blue BOS, Oil Blue #603, Oil Black BY, Oil Black BS, and Oil Black T-505 (all of which are manufactured by Orient Chemical Industries, Ltd.), and Victoria Pure Blue, Crystal Violet (CI42555), Methyl Violet (CI42535), Ethyl Violet, Rhodamine B (CI145170B), Malachite Green (CI42000), and Methylene Blue (CI52015).

When the acid dye is used in combination with the basic dye, the amount of the basic dye is less than 99.5% by mass based on the total mass of the colorant.

The lithographic printing original plate of the present invention includes an image forming layer containing a water-insoluble and alkali-soluble resin and photo-thermal conversion material on a substrate.

### <Water-Insoluble and Alkali-Soluble Resin>

The water-insoluble and alkali-soluble resin used in the image forming layer according to the present invention is a resin which is insoluble in water, and is soluble in a solution of an alkaline compound. As used herein, the term “alkali-soluble resin” also includes the meaning of alkali-dispersible resin. Examples of such alkali-soluble resin include a novolac resin, a polyvinylphenol-based resin, and a copolymer having alkali-soluble groups such as a carboxyl group, a phenolic hydroxyl group, a sulfonic acid group, a sulfonamide group, and an active imino group. Of these, a novolac resin or a polyvinylphenol-based resin is preferable. Examples of the novolac resin include those obtained by polycondensing at least one kind of aromatic hydrocarbons such as phenol, m-cresol, o-cresol, p-cresol, 2,5-xylenol, 3,5-xylenol, resorcin, pyrogallol, bisphenol, bisphenol-A, trisphenol, o-ethylphenol, m-ethylphenol, p-ethylphenol, propylphenol, n-butylphenol, t-butylphenol, t-butylphenol, 1-naphthol, and 2-naphthol, with at least one kind of aldehydes or ketones selected from aldehydes such as formaldehyde, acetaldehyde, propionaldehyde, benzaldehyde, and furfural, and ketones such as acetone, methyl ethyl ketone, and methyl isobutyl ketone in the presence of an acidic catalyst. Paraformaldehyde and paraldehyde may be respectively used in place of formaldehyde and acetaldehyde.

Aromatic hydrocarbons of the novolac resin are more preferably novolac resins obtained by polycondensing at least one kind of phenols selected from phenol, m-cresol, o-cresol, p-cresol, 2,5-xylenol, 3,5-xylenol, and resorcin, with at least one kind of aldehydes selected from formaldehyde, acetaldehyde, and propionaldehyde. Of these, preferred is a novolac resin which is a polycondensate of phenols and aldehydes in which a mixing ratio of m-cresol:p-cresol:2,5-xylenol:3,5-xylenol:resorcin is 40 to 100:0 to 50:0 to 20:0 to 20:0 to 20 in terms of a molar ratio. Alternatively, preferred is a novolac resin which is a polycondensate of phenols and aldehydes in which a mixing ratio of phenol, m-cresol, and p-cresol, that is, a mixing ratio of phenol:m-cresol:p-cresol is 70 to 100:0 to 30:0 to 20:0 to 20 in terms of a molar ratio. Alternatively, preferred is a novolac resin which is a polycondensate of phenols and aldehydes in which a mixing ratio of phenol:m-cresol:p-cresol is 10 to 100:0 to 60:0 to 40 in terms of a molar ratio.

The polystyrene-equivalent mass average molecular weight, which is obtained by gel permeation chromatography of a novolac resin used in an image forming layer according to the present invention, is preferably from 500 to 30,000. When the polystyrene-equivalent mass average molecular weight is less than 500, developing solution resistance of the unexposed portion may sometimes deteriorate. In contrast, when the polystyrene-equivalent mass average molecular weight is more than 30,000, developing properties of the exposed portion may sometimes deteriorate.

Examples of the polyvinylphenol-based resin include hydroxystyrenes alone, or two or more kinds of polymers. Examples of hydroxystyrenes include o-hydroxystyrene, m-hydroxystyrene, p-hydroxystyrene, 2-(O-hydroxyphenyl)propylene, 2-(m-hydroxyphenyl)propylene, and 2-(p-hydroxyphenyl)propylene. The hydroxystyrenes may have halogen such as chlorine, bromine, iodine, or fluorine, or a C₁-C₄ alkyl-substituent in the aromatic ring. The polyvinylphenol-based resin is usually synthesized by radical polymerization or cationic polymerization of hydroxystyrenes alone or two or more kinds thereof. Such polyvinylphenol-based resin may be partially hydrogenated. The polyvinylphenol-based resin may be a resin in which OH groups of polyvinylphenols are partially protected with a t-butoxycarbonyl group, a pyranyl group, or a furanyl group.

Of these polyvinylphenol-based resins, a polyvinylphenol resin is preferable. The polyvinylphenol may have a C₁-C₄ alkyl-substituent in the aromatic ring, and is particularly preferably polyvinylphenol having no substituent. The mass average molecular weight of the polyvinylphenol resin used in the image forming layer according to the present invention is preferably from 1,000 to 100,000. When the mass average molecular weight is less than 1,000, it may be sometimes impossible to sufficiently form a coating film. In contrast, when the mass average molecular weight is more than 100,000, the solubility of the exposed portion in an alkali developing solution may decrease, and thus failing to obtain a pattern.

Some of the above-mentioned water-insoluble and alkali-soluble resin may undergo a change in color thereof. In this case, a problem such as image contrast is less likely to arise. In general, a phenol resin often causes browning due to baking. When the water-insoluble and alkali-soluble resin used in the image forming layer is not a phenol resin, or the content of a small amount is low, baking does not cause a change in color of the resin per se, or there may arise a problem such as image contrast after baking because of less change in color. In such case, when an acid dye is added to the image forming layer, image density is prevented from decreasing, and thus obtaining satisfactory image contrast. Therefore, when the image forming layer does not contain a phenol resin, or the content of a phenol resin is low, the addition of the acid dye is particularly preferable.

Examples of such phenol resin include novolac resins such as a phenol novolac resin, a cresol novolac resin, and a modified novolac resin; and resol resins such as a bisphenol A resol resin, a cresol resol resin, and a phenolresol resin.

Regardless of the content of the phenol resin in the water-insoluble and alkali-soluble resin used in the image forming layer, the acid dye can be added as a colorant so as to increase image contrast after baking. When the content of the phenol resin is less than 50% by mass based on the total mass of the water-insoluble and alkali-soluble resin used in the image forming layer, remarkable image contrast improving effect may be exerted by adding the acid dye. When the content of the phenol resin is less than 40% by mass, further remarkable image contrast improving effect may be exerted.

It is possible to employ, as another aspect of the lithographic printing original plate of the present invention, the constitution in which the image forming has a two-layer structure comprising of a lower layer and an upper layer. The intermediate layer may be optionally formed between the lower layer and the substrate of the image forming layer. It is preferred that the intermediate layer is absent between the lower layer and the upper layer. A back coat layer may be optionally formed on a back surface of the substrate. From the viewpoint of simplification of the production of an original plate, it is preferable that the lower layer of the image forming layer is formed on a surface of the substrate in contact therewith, and the upper layer is formed on a surface of the lower layer in contact therewith.

### <Lower Layer>

The lower layer of the image forming layer, which constitutes the lithographic printing original plate of the present invention, contains a water-insoluble and alkali-soluble resin. It is preferred that the resin has at least functional groups such as a phenolic hydroxyl group, a carboxyl group, a sulfonic acid group, a phosphoric acid group, a phosphonic acid group, an active imino group, and a sulfonamide group so that the resin is soluble in an alkaline aqueous solution. Therefore, the resin, which is soluble in an alkaline aqueous solution, used in the lower layer can be preferably produced by polymerizing a monomer mixture containing one or more ethylenically unsaturated monomers having functional groups such as a phenolic hydroxyl group, a carboxyl group, a sulfonic acid group, a phosphoric acid group, a phosphonic acid group, an active imino group, a sulfonamide group, and a combination thereof.

The ethylenically unsaturated monomer can serve as a compound represented by the following formula:

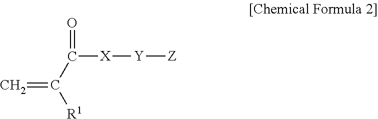

wherein R¹ is a hydrogen atom, a C₁₋₂₂ linear, branched, or cyclic alkyl group, a C₁₋₂₂ linear, branched, or cyclic substituted alkyl group, a C₆₋₂₄ aryl group, or a substituted aryl group, and a substituent is selected from a C₁₋₄ alkyl group, an aryl group, a halogen atom, a keto group, an ester group, an alkoxy group, or a cyano group; X is O, S, and NR², and R² is hydrogen, a C₁₋₂₂ linear, branched, or cyclic alkyl group, a C₁₋₂₂ linear, branched, or cyclic substituted alkyl group, a C₆₋₂₄ aryl group, or a substituted aryl group, and a substituent is selected from a C₁₋₄ alkyl group, an aryl group, a halogen atom, a keto group, an ester group, an alkoxy group, or a cyano group; Y is a single bond, or a C₁₋₂₂ linear, branched, or cyclic alkylene, alkyleneoxyalkylene, poly(alkyleneoxy)alkylene, or alkylene-NHCONH—; and Z is a hydrogen atom, a hydroxyl group, a carboxyl group, —C₆H₄—SO₂NH₂, —C₆H₃—SO₂NH₂(—OH), —OPO₃H₂, —PO₃H₂, or a group represented by the following formula:

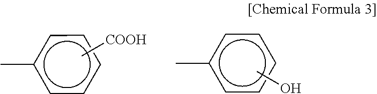

or

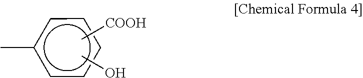

or a mixture thereof.

Examples of the ethylenically unsaturated monomer include, in addition to acrylic acid and methacrylic acid, compounds represented by the below-mentioned formulas, and a mixture thereof.

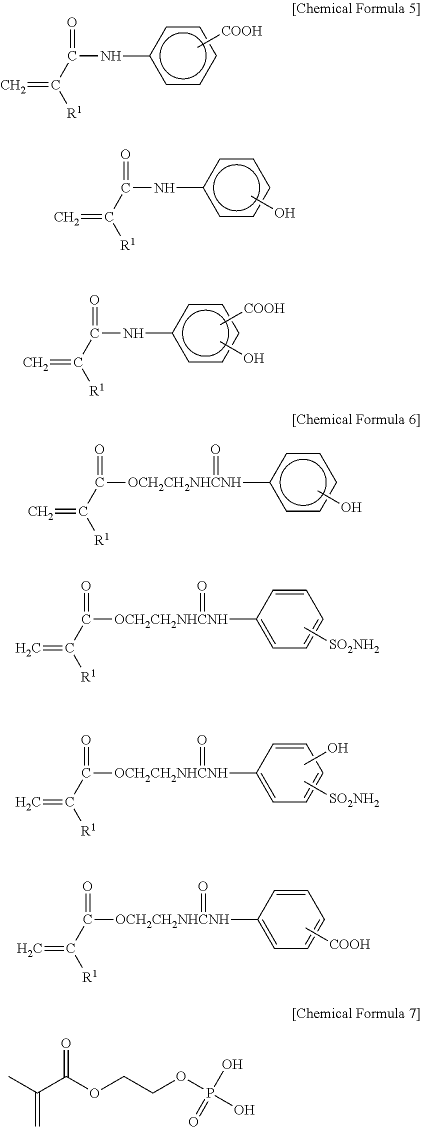

Ethylene glycol methacrylate phosmer (Phosmer M, manufactured by Uni-Chemical Co., Ltd.)

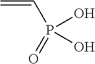

### Vinylsulfonic Acid

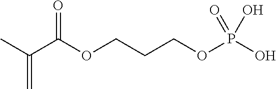

### 1,3-Propylene glycol methacrylate phosphate

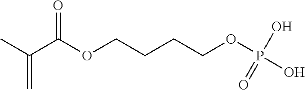

### 1,4-n-Butylene glycol methacrylate phosphate

The monomer mixture can contain other ethylenically unsaturated comonomers. Examples of the other ethylenically unsaturated comonomer include the following monomers:

acrylate esters such as methyl acrylate, ethyl acrylate, propyl acrylate, butyl acrylate, amyl acrylate, ethylhexyl acrylate, octyl acrylate, t-octyl acrylate, chloromethyl acrylate, 2,2-dimethylhydroxypropyl acrylate, 5-hydroxypentyl acrylate, trimethylolpropane monoacrylate, pentaerythritol monoacrylate, glycidyl acrylate, benzyl acrylate, methoxybenzyl acrylate, and tetrahydroacrylate;

aryl acrylates such as phenyl acrylate and furfuryl acrylate;

methacrylate esters such as methyl methacrylate, ethyl methacrylate, propyl methacrylate, isopropyl methacrylate, allyl methacrylate, amyl methacrylate, hexyl methacrylate, cyclohexyl methacrylate, benzyl methacrylate, chlorobenzyl methacrylate, octyl methacrylate, 4-hydroxybutyl methacrylate, 5-hydroxypentyl methacrylate, 2,2-dimethyl-3-hydroxypropyl methacrylate, trimethylolpropane monomethacrylate, pentaerythritol monomethacrylate, glycidyl methacrylate, furfuryl methacrylate, and tetrahydrofurfuryl methacrylate;

aryl methacrylates such as phenyl methacrylate, cresyl methacrylate, and naphthyl methacrylate;

N-alkylacrylamides such as N-methylacrylamide, N-ethylacrylamide, N-propylacrylamide, N-butylacrylamide, N-t-butylacrylamide, N-heptylacrylamide, N-octylacrylamide, N-cyclohexylacrylamide, and N-benzylacrylamide;

N-arylacrylamides such as N-phenylacrylamide, N-tolylacrylamide, N-nitrophenylacrylamide, N-naphthylacrylamide, and N-hydroxyphenylacrylamide;

N,N-dialkylacrylamides such as N,N-dimethylacrylamide, N,N-diethylacrylamide, N,N-dibutylacrylamide, N,N-dibutylacrylamide, N,N-diisobutylacrylamide, N,N-diethylhexylacrylamide, and N,N-dicyclohexylacrylamide;

N,N-arylacrylamides such as N-methyl-N-phenylacrylamide, N-hydroxyethyl-N-methylacrylamide, and N-2-acetamidoethyl-N-acetylacrylamide;

N-alkylmethacrylamides such as N-methylmethacrylamide, N-ethylmethacrylamide, N-propylmethacrylamide, N-butylmethacrylamide, N-t-butylmethacrylamide, N-ethylhexylmethacrylamide, N-hydroxyethylmethacrylamide, and N-cyclohexylmethacrylamide;

N-arylmethacrylamides such as N-phenylmethacrylamide and N-naphthylmethacrylamide;

N,N-dialkylmethacrylamides such as N,N-diethylmethacrylamide, N,N-dipropylmethacrylamide, and N,N-dibutylmethacrylamide;

N,N-diarylmethacrylamides such as N,N-diphenylmethacrylamide;

methacrylamide derivatives such as N-hydroxyethyl-N-methylmethacrylamide, N-methyl-N-phenylmethacrylamide, and N-ethyl-N-phenylmethacrylamide;

allyl compounds such as allyl acetate, allyl caproate, allyl caprylate, allyl laurate, allyl palmitate, allyl stearate, allyl benzoate, allyl acetoacetate, allyl lactate, and allyloxyethanol;

vinyl ethers such as hexyl vinyl ether, octyl vinyl ether, dodecyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether, tetrahydrofurfuryl vinyl ether, vinyl phenyl ether, vinyl tolyl ether, vinyl chlorophenyl ether, vinyl-2,4-dichlorophenyl ether, vinyl naphthyl ether, and vinyl antharanyl ether;

vinyl esters such as vinyl butyrate, vinyl isobutyrate, vinyl trimethyl acetate, vinyl diethyl acetate, vinyl valerate, vinyl caproate, vinyl chloroacetate, vinyl methoxyacetate, vinyl butoxyacetate, vinyl phenylacetate, vinyl acetoacetate, vinyl lactate, vinyl-β-phenyl butyrate, vinyl cyclohexylcarboxylate, vinyl benzoate, vinyl salicylate, chlorovinyl benzoate, tetrachlorovinyl benzoate, and vinyl naphthoate;

styrenes such as styrene, methylstyrene, dimethylstyrene, trimethylstyrene, ethylstyrene, diethylstyrene, isopropylstyrene, butylstyrene, hexylstyrene, cyclohexylstyrene, dodecylstyrene, benzylstyrene, chloromethylstyrene, trifluoromethylstyrene, ethoxymethylstyrene, acetoxymethylstyrene, methoxystyrene, 4-methoxy-3-methylstyrene, dimethoxystyrene, chlorostyrene, dichlorostyrene, trichlorostyrene, tetrachlorostyrene, pentachlorostyrene, bromostyrene, dibromostyrene, iodostyrene, fluorostyrene, 2-bromo-4-trifluoromethylstyrene, and 4-fluoro-3-trifluoromethylstyrene;

crotonate esters such as butyl crotonate, hexyl crotonate, crotonic acid, and glycerin monocrotonate;

dialkyl itaconates such as dimethyl itaconate, diethyl itaconate, and dibutyl itaconate;

dialkyls of maleic acid or fumaric acid, such as dimethyl maleate and dibutyl fumarate;

maleimides such as N-methylmaleimide, N-ethylmaleimide, N-propylmaleimide, N-butylmaleimide, N-phenylmaleimide, N-2-methylphenylmaleimide, N-2,6-diethylphenylmaleimide, N-2-chlorophenylmaleimide, N-cyclohexylmaleimide, N-laurylmaleimide, and N-hydroxyphenylmaleimide; and

other nitrogen atom-containing monomers such as N-vinylpyrrolidone, N-vinylpyridine, acrylonitrile, and methacrylonitrile.

Of these other ethylenically unsaturated comonomer monomers, for example, (meth)acrylate esters, (meth)acrylamides, maleimides, and (meth)acrylonitriles are preferably used.

The mass average molecular weight of the water-insoluble and alkali-soluble resin used in the image forming layer of the present invention is preferably within a range from 20,000 to 100,000. When the mass average molecular weight of the water-insoluble and alkali-soluble resin is less than 20,000, solvent resistance and abrasion resistance may be inferior. In contrast, when the mass average molecular weight of the water-insoluble and alkali-soluble resin is more than 100,000, alkali developing properties may be inferior.

The content of the water-insoluble and alkali-soluble resin in the lower layer is preferably within a range from 20 to 95% by mass based on the solid content of the layer. When the content of the water-insoluble and alkali-soluble resin is less than 20% by mass, it may be inconvenient in view of chemical resistance. In contrast, when the content of the water-insoluble and alkali-soluble resin is more than 95% by mass, it may not be preferable in view of an exposure speed. Two or more kinds of water-insoluble and alkali-soluble resins may be optionally used in combination.

### <Upper Layer>

The upper layer, which constitutes the image forming layer of the lithographic printing original plate of the present invention, contains a water-insoluble and alkali-soluble resin. The water-insoluble and alkali-soluble resin, which can be used in the upper layer, is preferably a resin having a carboxylic acid group or an acid anhydride group, and examples thereof include a copolymer obtained by polymerizing a monomer mixture containing an unsaturated carboxylic acid and/or an unsaturated carboxylic anhydride, and polyurethane having a substituent containing an acidic hydrogen atom. Examples of the unsaturated carboxylic acid and/or the unsaturated carboxylic anhydride include acrylic acid, methacrylic acid, maleic acid, maleic anhydride, itaconic acid, and itaconic anhydride. Examples of a copolymerizable ethylenically unsaturated monomer unit include the above-mentioned other ethylenically unsaturated comonomers.

The acidic hydrogen atom of the polyurethane having a substituent containing an acidic hydrogen atom can belong to acidic functional groups such as a carboxyl group, a —SO₂NHCOO— group, a —CONHSO₂— group, a —CONHSO₂NH— group, and an —NHCONHSO₂— group. An acidic hydrogen atom derived from a carboxy group is particularly preferable.

The polyurethane having an acidic hydrogen atom can be synthesized, for example, by a method of reacting diol having a carboxy group and, optionally, other dials, with diisocyanate; a method of reacting diol with diisocyanate having a carboxy group and, optionally, other diisocyanates; or a method of reacting diol having a carboxy group and, optionally, other dials, with diisocyanate having a carboxy group and, optionally, other diisocyanates.

Examples of the dial having a carboxy group include 3,5-dihydroxybenzoic acid, 2,2-bis(hydroxymethyl)propionic acid, 2,2-bis(hydroxyethyl)propionic acid, 2,2-bis(3-hydroxypropylpropionic acid, 2,2-bis(hydroxymethyl)acetic acid, bis-(4-hydroxyphenyl)acetic acid, 4,4-bis-(4-hydroxyphenyl)pentanoic acid, and tartaric acid. Of these, 2,2-bis(hydroxymethyl)propionic acid is more preferable in view of reactivity with isocyanate.

Examples of the other diol include dimethylolpropane, polypropylene glycol, neopentyl glycol, 1,3-propanediol, polytetramethylene ether glycol, polyester polyol, polymer polyol, polycaprolactone polyol, polycarbonate diol, 1,4-butanediol, 1,5-pentadiol, 1,6-hexanediol, and polybutadiene polyol.

Examples of the diisocyanate having a carboxy group include dimer acid diisocyanate.

Examples of the other diisocyanate include 4,4′-diphenylmethane diisocyanate, xylylene diisocyanate, naphthylene-1,5-diisocyanate, tetramethylxylene diisocyanate, hexamethylene diisocyanate, toluene-2,4-diisocyanate, isophorone diisocyanate, hydrogenated xylylene diisocyanate, dicyclohexylmethane diisocyanate, norbornene diisocyanate, and trimethylhexamethylene diisocyanate.

A molar ratio of diisocyanate to diol is preferably from 0.7:1 to 1.5:1. When isocyanate groups remain at the polymer end, the polymer is finally synthesized, in a state where isocyanate groups do not remain, by treating with alcohols or amines.

The mass average molecular weight of the copolymer including an unsaturated carboxylic acid unit and/or an unsaturated carboxylic anhydride unit is preferably within a range from 800 to 10,000. When the mass average molecular weight of the copolymer including an unsaturated carboxylic acid unit and/or an unsaturated carboxylic anhydride unit is less than 800, the image area obtained by forming an image may be weak and inferior in developing solution resistance. In contrast, when the mass average molecular weight of the copolymer including an unsaturated carboxylic anhydride unit is more than 10,000, the image forming layer may be inferior in sensitivity. The mass average molecular weight of the polyurethane having a substituent containing an acidic hydrogen atom is preferably within a range from 2,000 to 100,000. When the mass average molecular weight of the polyurethane is less than 2,000, the image area obtained by forming an image may be weak and inferior in press life. In contrast, when the mass average molecular weight of the polyurethane is more than 100,000, the image forming layer may be inferior in sensitivity.

The content of the copolymer including an unsaturated carboxylic acid unit and/or an unsaturated carboxylic anhydride unit in the upper layer is preferably within a range from 10 to 100% by mass based on the solid content of the layer. It is not preferred that the content of the copolymer including an unsaturated carboxylic acid unit and/or an unsaturated carboxylic anhydride unit is less than 10% by mass since it may be inconvenient in view of developing solution resistance. In contrast, the content of the copolymer including an unsaturated carboxylic acid unit and/or an unsaturated carboxylic anhydride unit, or the content of the polyurethane having a substituent containing an acidic hydrogen atom is preferably within a range from 2 to 90% by mass based on the solid content of the layer. When the content of the polyurethane having a substituent containing an acidic hydrogen atom is less than 2% by mass, it may be inconvenient in view of a development speed. In contrast, when the content of the polyurethane having a substituent containing an acidic hydrogen atom is more than 90% by mass, it may not be preferred in view of storage stability. Polyurethane having a substituent containing two or more kinds of acidic hydrogen atoms may be optionally used in combination. Furthermore, two or more kinds of a copolymer including an unsaturated carboxylic anhydride unit, a copolymer including an unsaturated carboxylic acid unit, or polyurethane having a substituent containing an acidic hydrogen atom may be used in combination.

### <Photo-Thermal Conversion Material>

The image forming layer of the lithographic printing original plate of the present invention contains a photo-thermal conversion material. When the image forming layer comprises of two layers, that is, a lower layer and an upper layer, the lower layer and/or the upper layer contain(s) a photo-thermal conversion material. It is considered that in case the photo-thermal conversion material exists only in the lower layer, when an image is formed on the lithographic printing original plate of the present invention by laser, the photo-thermal conversion material contained in the lower layer enables conversion of laser beam into heat and the heat is transferred to the upper layer thereby causing collapse of a partial molecular structure of an alkali-soluble resin of the outermost layer to form pores in the upper layer, and thus enabling penetration of a developing solution into the lower layer.

The photo-thermal conversion material means any material capable of converting electromagnetic wave into thermal energy and is a material having a maximum absorption wavelength within the near infrared to the infrared region, specifically a material having a maximum absorption wavelength within a range from 760 nm to 1,200 nm. Examples of the material include various pigments and dyes.

It is possible to use, as the pigment which can be used in the present invention, commercially available pigments and pigments disclosed in the Color Index Manual “Saishin Ganryou Binran” (New Manual of Pigments), edited by the Japan Pigment Technology Association, 1977, “Saishin Ganryou Ouyou Gijutsu” (New Applied Technology) for Pigment, CMC Publishing, 1986), and “Insatsu Inki Gijutsu” (Printing Ink Technology), CMC Publishing, 1984. The types of pigments include black pigments, yellow pigments, orange pigments, brown pigments, red pigments, violet pigments, blue pigments, green pigments, fluorescent pigments and, in addition, polymer bound coloring pigments. Specifically, it is possible to use insoluble azo pigments, azo lake pigments, condensed azo pigments, chelate azo pigments, phthalocyanine-based pigments, anthraquinone-based pigments, perylene- and perinone-based pigments, thioindigo-based pigments, quinacridone-based pigments, dioxazine-based pigments, isoindolinone-based pigments, quinophthalone-based pigments, dye lake pigments, azine pigments, nitroso pigments, nitro pigments, natural pigments, fluorescent pigments, inorganic pigments, and carbon black.

Of these specific examples, carbon black is particularly preferable as a material which absorbs near infrared rays to rays in an infrared region to efficiently generate heat, and is also economically competitive. Carbon blacks having various functional groups and having excellent dispersibility are commercially available and, for example, it is possible to preferably use carbon blacks disclosed in “Carbon Black Manual, 3rd edition” (edited by the Carbon Black Association, 1995), p. 167 and “Characteristics of Carbon Black and Optimal Formulation and Applied Technology” (Technical Information Association), 1997, p. 111 in the present invention.

These pigments may be used without a surface treatment or may be subjected to a known surface treatment. It is possible to use, as a known surface treating method, a method of surface-coating a resin or wax; a method of adhering a surfactant; and a method in which a reactive material such as a silane coupling agent, an epoxy compound, or polyisocyanate is bound to a surface of a pigment. These surface treating methods are disclosed in “Kinzoku Sekken no Seishitsu to Ouyou” (Properties of Metal Soaps and Their Application), Saiwai Shobo; “Saishin Ganryou Ouyou Gijutsu” (New Applied Technology for Pigment), CMC Publishing, 1986; and “Insatsu Inki Gijutsu” (Printing Ink Technology), CMC Publishing, 1984. The pigment used in the present invention preferably has a particle diameter within the range from 0.01 to 15 μm, and more preferably from 0.01 to 5 μm.

It is possible to use, as the dye which can be used in the present invention, conventionally known dyes, and examples thereof include those disclosed in “Senryou Binran” (Dye Manual), edited by the Organic Synthesis Chemistry Association, 1970; “Shikizai Kougaku Handobukku” (Coloring Material Engineering Handbook), edited by the Coloring Material Association, Asakura Shoten, 1989; “Kougyouyou Shikiso no Gijutsu to Shijyou” (Technology and Market of Industrial Coloring Matter), edited by CMC, 1983; and “Kagaku Binran Ouyou Kagaku Hen” (Chemistry Manual Applied Chemistry Version), edited by the Japan Chemistry Society, Maruzen Shoten, 1986. More specific examples thereof include dyes such as azo dyes, metal complex azo dyes, pyrazolone azo dyes, anthraquinone dyes, phthalocyanine dyes, carbonium dyes, quinoneimine dyes, methine dyes, cyanine dyes, indigo dyes, quinoline dyes, nitro-based dyes, xanthene-based dyes, thiazine-based dyes, azine dyes, and oxazine dyes.

It is possible to use, as dyes which absorb near infrared to infrared rays, for example, dyes such as azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squalirium dyes, pyrylium salts, and metal thiolate complexes (for example, nickelthiolate complex, etc.). Of these dyes, cyanine dyes are preferable, and examples thereof include cyanine dyes represented by the general formula (I) disclosed in Japanese Unexamined Patent Publication (Kokai) No. 2001-305722 and compounds disclosed in paragraphs [0096] to [0103] of Japanese Unexamined Patent Publication (Kokai) No. 2002-079772.

Particularly preferred photo-thermal conversion materials are dyes having the following formulas:

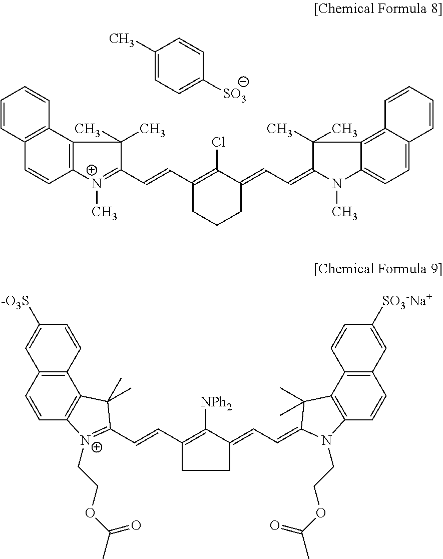

wherein Ph represents a phenyl group.

The photo-thermal conversion material can be added in the amount of 0.01 to 50% by mass, preferably 0.1 to 20% by mass, and particularly preferably 1 to 15% by mass, based on the mass of the lower or upper layer. When the amount is less than 0.01% by mass, sensitivity may decrease. In contrast, when the amount is more than 50% by mass, stains may be formed at the non-image area upon printing. When the photo-thermal conversion material is added to both the lower and upper layers, the total addition amount of the lower and upper layers can be within a range from 0.01 to 50% by mass, preferably from 0.1 to 20% by mass, and particularly preferably from 1 to 15% by mass, based on the total mass of the lower and upper layers of the image forming layer. These photo-thermal conversion materials may be used alone, or two or more kinds of them may be used in combination.

### <Image Forming Layer and Other Constituent Component>

It is possible to optionally add, in addition to the above-mentioned components, known additives, for example, surfactants, plasticizers, stability improvers, development accelerators, development inhibitors, and lubricants (silicone powders, etc.) to the image forming layer of the lithographic printing original plate of the present invention.

Examples of the surfactant include fluorine-based surfactants and silicone-based surfactants.

Examples of the plasticizer include diethyl phthalate, dibutyl phthalate, dioctyl phthalate, tributyl phosphate, trioctyl phosphate, cresyl phosphate, phosphoric acid tri(2-chloroethyl) phosphate, and tributyl citrate.

It is also possible to use, as the known stability improver, phosphoric acid, phosphorus acid, oxalic acid, tartaric acid, malic acid, citric acid, dipicolinic acid, polyacrylic acid, benzenesulfonic acid, and toluenesulfonic acid.

Examples of the other stability improver include known phenolic compounds, quinones, N-oxide compounds, amine-based compounds, sulfide group-containing compounds, nitro group-containing compounds, and transition metal compounds. Specific examples thereof include hydroquinone, p-methoxyphenol, p-cresol, pyrogallol, t-butylcatechol, benzoquinone, 4,4′-thiobis(3-methyl-6-t-butylphenol), 2,2′-methylenebis(4-methyl-6-t-butylphenol), 2-mercaptobenzimidazole, and N-nitrosophenylhydroxyamine primary cerium salt.

Examples of the development accelerator include acid anhydrides, phenols, and organic acids. Acid anhydrides are preferably cyclic anhydrides. Specifically, it is possible to use, as the cyclic anhydride, those disclosed in the specification of U.S. Pat. No. 4,115,128, for example, phthalic anhydride, tetrahydrophthalic anhydride, hexahydrophthalic anhydride, 3,6-endoxy-tetrahydrophthalic anhydride, tetrachlorophthalic anhydride, maleic anhydride, chloromaleic anhydride, α-phenylmaleic anhydride, succinic anhydride, and pyromellitic anhydride. Examples of the non-cyclic anhydride include acetic anhydride. Examples of phenols include bisphenol A, 2,2′-bishydroxysulfon, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, and 4,4′,″, 4″-tetrahydroxy-3,5,3′,5′-tetramethyltriphenylmethan.

Examples of organic acids include those disclosed in Japanese Unexamined Patent Publication (Kokai) No. 60-88942 and Japanese Unexamined Patent Publication (Kokai) No. 2-96755, for example, sulfonic acids, sulfinic acids, alkylsulfuric acids, phosphonic acids, phosphate esters, and carboxylic acids, and specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

The development inhibitor is not particularly limited as long as it causes an interaction with the alkali-soluble resin and substantially lowers solubility of the alkali-soluble resin in the developing solution in the unexposed portions, and also becomes soluble in the developing solution as a result of the weakened interaction in the exposed portions. In particular, quaternary ammonium salts and polyethylene glycol base compounds are used particularly preferably. Of the above photo-thermal conversion materials and colorants, some compounds function as the development inhibitor and are preferably exemplified. The development inhibitor further includes substances, which are heat-decomposable and substantially lowers solubility of the alkali-soluble resin in a non-decomposable state, for example, onium salts, o-quinonediazide compounds, aromatic sulfone compounds, and aromatic sulfonate ester compounds.

The amount of these various additives varies depending on the purposes, and is preferably within a range from 0 to 30% by mass based on the solid content of the image recording layer.

In addition, other alkali-soluble or dispersible resins can be optionally used in combination in the image recording layer of the lithographic printing original plate of the present invention. Examples of the other alkali-soluble or dispersible resin include polyester resins and acetal resins.

In the lithographic printing original plate of the present invention, the outermost layer may contain matting agents for the purpose of improving interleaving paper peelability and improving plate transport properties of an automatic plate loader. Alternatively, a matting layer may be disposed on the outermost layer.

<Substrate>

Examples of the substrate include metal plates made of aluminum, zinc, copper, stainless steel, and iron; plastic films made of polyethylene terephthalate, polycarbonate, polyvinyl acetal, and polyethylene; composite materials obtained by forming a metal layer on a plastic film, which is melt-coated or coated with a synthetic resin solution, using technologies such as vacuum deposition and laminate; and a material used as the substrate of the printing plate. It is particularly preferred to use a substrate made of aluminum or a composite substrate coated with aluminum.

It is preferred that the surface of the aluminum substrate is surface-treated for the purpose of enhancing water retentivity and improving adhesion with a lower layer or an intermediate layer formed optionally between the lower layer and the substrate. Examples of the surface treatment include roughening treatments such as brush polishing method, ball polishing method, electrolytic etching, chemical etching, liquid honing, and sandblast, and a combination thereof. Of these, a roughening treatment including the use of electrolytic etching is particularly preferred.

As an electrolytic bath in the case of electrolytic etching, for example, an aqueous solution containing an acid, an alkali, or a salt thereof, or an aqueous solution containing an organic solvent is used. Of these, an electrolytic solution containing hydrochloric acid, nitric acid, or a salt thereof is particularly preferable.

Furthermore, the aluminum substrate subjected to the roughening treatment is optionally subjected to a desmutting treatment using an aqueous solution of an acid or an alkali. It is preferred that the aluminum substrate thus obtained is subjected to an anodizing treatment. It is particularly preferred that the anodizing treatment is performed using a bath containing sulfuric acid or phosphoric acid.

After the anodizing treatment, the aluminum substrate can be subjected to a hydrophilization treatment or provided with an under coat layer. For example, the aluminum substrate can be subjected to a silicate treatment (sodium silicate, potassium silicate), a potassium fluorozirconate treatment, a phosphomolybdate treatment, an alkyl titanate treatment, a polyacrylic acid treatment, a polyvinylsulfonic acid treatment, a polyvinylphosphonic acid treatment, a vinylphosphonic acid-methacrylic acid copolymer treatment, a vinylphosphonic acid-acrylamide copolymer treatment, phytic acid treatment, a treatment using a salt of a hydrophilic organic polymer compound and a divalent metal, a fused arylsulfonate treatment (British Patent Application No. 2,098,627 and Japanese Unexamined Patent Publication (Kokai) No. 57-195697), a hydrophilization treatment by undercoating of a water-soluble polymer having a sulfonic acid group, and a treatment of silicate electrodeposition.

An aluminum substrate, which was subjected to a sealing treatment after subjecting to the roughening treatment (graining treatment) and the anodizing treatment, is also preferred. The sealing treatment is performed by immersing an aluminum substrate in a hot aqueous solution containing hot water and an inorganic salt or an organic salt, or performed using a steam bath.

The lithographic printing original plate of the present invention is produced by dissolving or dispersing constituent components of an image forming layer in an organic solvent (or dissolving or dispersing constituent components of a lower layer and an upper layer in an organic solvent when the image forming layer comprises of two layers), sequentially coating the resultant solution or dispersion on a substrate, and drying the solution or dispersion to form an image forming layer on the substrate.

As the organic solvent in which constituent components of the image forming layer are dissolved or dispersed, any conventionally known organic solvent can be used. In view of an advantage upon drying, an organic solvent having a boiling point within a range from 40 to 220° C., and particularly from 60 to 160° C. is selected.

Examples of the organic solvent include alcohols such as methyl alcohol, ethyl alcohol, n- or iso-propyl alcohol, n- or iso-butyl alcohol, and diacetone alcohol; ketones such as acetone, methyl ethyl ketone, methyl propyl ketone, methyl butyl ketone, methyl amyl ketone, methyl hexyl ketone, diethyl ketone, diisobutyl ketone, cyclohexanone, methylcyclohexanone, and acetylacetone; hydrocarbons such as hexane, cyclohexane, heptane, octane, nonane, decane, benzene, toluene, xylene, and methoxybenzene; acetate esters such as ethyl acetate, n- or iso-propyl acetate, n- or iso-butyl acetate, ethylbutyl acetate, and hexyl acetate; halides such as methylene dichloride, ethylene dichloride, and monochlorobenzene; ethers such as isopropyl ether, n-butyl ether, dioxane, dimethyldioxane, and tetrahydrofuran; polyhydric alcohols such as ethylene glycol, ethylene glycol monomethyl ether, ethylene glycol monomethyl ether acetate, ethylene glycol monoethyl ether, ethylene glycol monoethyl ether acetate, ethylene glycol monobutyl ether, ethylene glycol monobutyl ether acetate, ethylene glycol dimethyl ether, ethylene glycol diethyl ether, ethylene glycol dibutyl ether, methoxyethoxyethanol, diethylene glycol monomethyl ether, diethylene glycol dimethyl ether, diethylene glycol methylethyl ether, diethylene glycol diethyl ether, propylene glycol, propylene glycol monomethyl ether, propylene glycol monomethyl ether acetate, propylene glycol monoethyl ether, propylene glycol monoethyl ether acetate, propylene glycol monobutyl ether, 3-methyl-3-methoxybutanol, and 1-methoxy-2-propanol, and a derivative thereof; and special solvents such as γ-butyrolactone, N-methylpyrrolidone, N,N-dimethylacetamide, dimethyl sulfoxide, N,N-dimethylformamide, methyl lactate, and ethyl lactate. These organic solvents are used alone or in combination. It is also possible to use water in combination with these organic solvents. The solid content of the solution or dispersion to be coated is preferably from 2 to 50% by mass. The solid content as used herein means components excluding the organic solvent and moisture.

It is possible to use, as the method of coating the solution or dispersion of constituent components of the image forming layer, for example, methods such as roll coating, dip coating, air knife coating, gravure coating, gravure offset coating, hopper coating, blade coating, wire doctor coating, spray coating, and die coating methods. The coating amount is preferably within a range from 10 to 100 ml/m².

The solution or dispersion coated on the substrate is usually dried by heated air. The drying temperature (temperature of heat air) is preferably within a range from 30 to 200° C., and particularly from 40 to 140° C. The solution or dispersion can also be dried by not only a method of maintaining the drying temperature at a given temperature during drying, but also a method of stepwisely raising the drying temperature.

Preferred results may be sometimes obtained by dehumidifying drying air. The dry air is preferably supplied to the surface to be coated at a wind velocity within a range from 0.1 to 30 m/sec, and particularly preferably from 0.5 to 20 m/sec.

In the case of a single layer, the coating amount of the image coating layer is usually within the range from about 0.1 to about 10 g/m². When the image forming layer has a two-layer structure, the coating amount of the lower layer and upper layer, each dependently, is within the range from about 0.1 to about 5 g/m² in terms of dry mass.

### <Exposure and Development>

The lithographic printing original plate of the present invention can be used as a so-called CTP plate capable of directly writing an image on the plate based on digital image information from a computer using a laser.

As a laser beam source in the present invention, a high-output laser having a maximum strength in a near infrared to infrared region is used most preferably. Examples of the high-output laser having a maximum strength in the near infrared to infrared region include various lasers, each having a maximum strength in the near infrared to infrared region of 760 to 1,200 nm, for example, a semiconductor laser and a YAG laser.

As a developing solution for use in development after exposure, for example, an aqueous alkali solution is preferably used. Examples of the alkaline compound used in the aqueous alkali solution include an aqueous solution of inorganic alkali compounds such as sodium hydroxide, potassium hydroxide, sodium carbonate, potassium carbonate, sodium methasilicate, potassium methasilicate, secondary sodium phosphate, and tertiary sodium phosphate; and organic amines such as monomethylamine, dimethylamine, trimethylamine, monoethylamine, diethylamine, triethylamine, monoisopropylamine, diisopropylamine, n-butylamine, di-n-butylamine, monoethanolamine, diethanolamine, triethanolamine, ethyleneimine, and ethylenediamine. It is possible to optionally add anionic surfactants, amphoteric surfactants, and organic solvents to the developing solution. Examples of the organic solvent, which can be added to the developing solution, include ethyl acetate, butyl acetate, amyl acetate, benzyl acetate, ethylene glycol monobutyl acetate, butyl lactate, butyl levulinate, methyl ethyl ketone, ethyl butyl ketone, methyl isobutyl ketone, cyclohexanone, ethylene glycol monobutyl ether, ethylene glycol monobenzyl ether, ethylene glycol monophenyl ether, benzyl alcohol, methyl phenyl carbitol, n-amyl alcohol, methylamyl alcohol, xylene, methylene dichloride, ethylene dichloride, and monochlorobenzene. When the organic solvent is added to the developing solution, the amount of the organic solvent is preferably 20% by mass or less, and particularly preferably 10% by mass or less.

For the purpose of improving press life of the lithographic printing plate of the present invention, the lithographic printing plate is subjected to a baking treatment after the developing treatment.

The baking treatment is carried out by the steps of (i) washing the lithographic printing plate obtained by the above treating method to remove a rinsing solution or a gum solution, followed by squeezing, (ii) spreading a counter-etching solution over the entire plate without causing unevenness, followed by drying, (iii) performing baking under the temperature conditions of 180 to 300° C. in an oven for 1 to 30 minutes, and (iv) washing the plate with water to remove the counter-etching solution after cooling, followed by gumming and further drying.

### EXAMPLES

The present invention will be described in more detail below by way of Examples. However, the present invention is not limited to these Examples.

### Synthesis of Material for Hydrophilization Treatment of Substrate

### <Polymer 1>

Vinylphosphonic acid-Acrylamide Copolymer (molar ratio 1:9)

In a 10 liter flask equipped with a stirrer, a condenser, and a dropping device, 3,500 g of ethanol was charged and heated to 70° C. Then, 231.1 g (2.14 mol) of a vinylphosphonic acid monomer, 1368.9 g (19.26 mol) of acrylamide, and 52 g of AIBN were dissolved in 1,000 g of ethanol and this solution was added dropwise in a reactor over 4 hours. During dropwise addition of the monomer solution, a white precipitated was produced. After heating with stirring for 2 hours while maintaining at 70° C., heating was stopped, followed by cooling to room temperature. The precipitated white powder was separated by filtration, washed with 1,000 g of ethyl acetate and then dried.

### Production of Substrate

A 0.24 mm thick aluminum plate was degreased in an aqueous sodium hydroxide solution and then subjected to an electrolytic polishing treatment in a 2% hydrochloric acid bath to obtain a grained plate having a center line average roughness (Ra) of 0.5 μm. Then, the grained plate was subjected to an anodizing treatment in a 20% sulfuric acid bath at a current density of 2 A/dm² to form an oxide film (2.7 g/m²). After washing with water and drying, an aluminum substrate was obtained. The substrate thus obtained was immersed in an aqueous 0.5 g/L solution of a polymer 1 heated to 60° C. for 10 seconds, washed with water and then dried. Thus, a substrate for lithographic printing original plate was obtained.

### Synthesis of Alkali-Soluble Resin for Image Forming Layer

### <Resin Synthesis Example>

In a 10 liter flask equipped with a stirrer, a condenser, and a dropping device, 2,990 g of dimethylacetamide was charged and heated to 90° C. Then, 740.5 g of phenylmaleimide, 1,001 g of methacrylamide, 368 g of methacrylic acid, 643 g of acrylonitrile, 203.6 g of Phosmer M (manufactured by Uni-Chemical Co., Ltd.), 222.5 g of styrene, 10.6 g of AIBN, and 16 g of n-dodecylmercaptan were dissolved in 2,670 g of dimethylacetamide, and the resultant solution was added dropwise in a reactor over 2 hours. After completion of the dropwise addition, 5.3 g of AIBN was added and the temperature was raised to 100° C., followed by stirring for 4 hours. During stirring, 5.3 g of AIBN was added every 1 hour and the reaction was carried out.

After completion of the reaction, heating was stopped, followed by cooling to room temperature. The reaction solution was poured into 50 liter of water and the resultant precipitate was collected by vacuum filtration at 50° C. for 24 hours, washed with water and then collected again by vacuum filtration to obtain a binder resin 1. The amount of the resin 1 was 2,873 g (yield: 90%).

### Formation of Two-Layer Type Image Forming Layer

### Preparation of Coating Solution for Lower Layer

Coating solutions for lower layer B-1 to B-8 shown in Table 1 below were prepared. An acid dye as a colorant was added to the coating solutions B-1, B-2, and B-7, and a basic dye was added to the coating solutions B-3 to B-6, and B-8.

TABLE 1
Formulation of coating solution for lower layer

| | B-1 | B-2 | B-3 | B-4 |
|---|---|---|---|---|
| Methyl ethyl ketone | 47.28 | 47.28 | 47.28 | 47.28 |
| Propylene glycol | 28.80 | 28.80 | 28.80 | 28.80 |
| monomethyl ether | | | | |
| γ-Butyrolactone | 9.46 | 9.46 | 9.46 | 9.46 |
| Water | 9.46 | 9.46 | 9.46 | 9.46 |
| Resin 1 | 3.95 | 3.95 | 3.95 | 3.95 |
| Cyanine IR dye A | 0.50 | 0.50 | 0.50 | 0.50 |
| Cyanine IR dye B | 0.40 | 0.40 | 0.40 | 0.40 |
| Dye | 0.10 | 0.10 | 0.10 | 0.10 |
| | Acid Red 52 | Acid Red 87 | Crystal Violet | D11 |
| | (Acid dye) | (Acid dye) | (Basic dye) | (Basic dye) |
| DOW CORNING TORAY | 0.05 | 0.05 | 0.05 | 0.05 |
| 8019 ADDITIVE* | | | | |

| | B-5 | B-6 | B-7 | B-8 |
|---|---|---|---|---|
| Methyl ethyl ketone | 47.28 | 47.28 | 47.28 | 47.28 |
| Propylene glycol | 28.80 | 28.80 | 28.80 | 28.80 |
| monomethyl ether | | | | |
| γ-Butyrolactone | 9.46 | 9.46 | 9.46 | 9.46 |
| Water | 9.46 | 9.46 | 9.46 | 9.46 |
| Resin 1 | 3.95 | 3.95 | 3.05 | 3.05 |
| Cyanine IR dye A | 0.50 | 0.50 | 1.00 | 1.00 |
| Cyanine IR dye B | 0.40 | 0.40 | 0.80 | 0.80 |
| Dye | 0.10 | 0.10 | 0.10 | 0.10 |
| | Brilliant | New Fuchsin | Acid Red 52 | New Fuchsin |
| | (Basic dye) | (Basic dye) | (Acid dye) | (Basic dye) |
| DOW CORNING TORAY | 0.05 | 0.05 | 0.05 | 0.05 |
| 8019 ADDITIVE* | | | | |

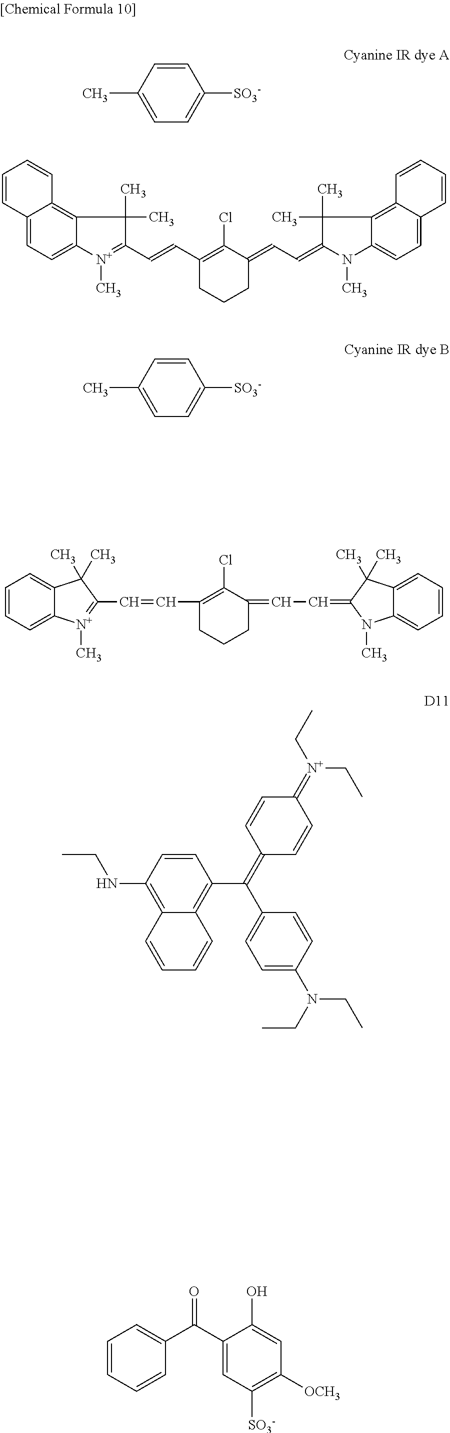

### Preparation of Coating Solution for Upper Layer

Coating solutions for upper layer T-1 to T-10 shown in Table 2 were prepared. An acid dye as a colorant was added to the coating solutions T-1 to T-4, and a basic dye was added to the coating solutions T-5 to T-10.

TABLE 2
Formulation of coating solution for upper layer

| | T-1 | T-2 | T-3 | T-4 | T-5 | T-6 |
|---|---|---|---|---|---|---|
| Methyl ethyl ketone | 45.00 | 45.00 | 45.00 | 45.00 | 45.00 | 45.00 |
| Propylene glycol | 40.32 | 40.32 | 40.32 | 25.53 | 40.32 | 40.32 |
| monomethyl ether | | | | | | |
| Propylene glycol | 9.50 | 9.50 | 9.50 | 9.50 | 9.50 | 9.50 |
| monomethyl ether acetate | | | | | | |
| SMA resin* (having an average | 4.93 | 4.93 | — | — | 4.93 | 4.93 |
| molecular weight of 2,000) | | | | | | |
| Alkylphenol novolac resin | — | — | 4.93 | — | | |
| SP-1077 (manufactured by | | | | | | |
| Schenectady) | | | | | | |
| Bisphenol A type resole resin | — | — | — | 19.72 | | |
| (25% propylene glycol | | | | | | |
| monomethyl ether solution) | | | | | | |
| Dye | 0.20 | 0.20 | 0.20 | 0.20 | 0.20 | 0.20 |
| | Acid Red 52 | Acid Red 87 | Acid Red 52 | Acid Red 52 | Crystal Violet | D11 |
| | (Acid dye) | (Acid dye) | (Acid dye) | (Acid dye) | (Basic dye) | (Basic dye) |
| DOW CORNING TORAY | 0.05 | 0.05 | 0.05 | 0.05 | 0.05 | 0.05 |
| 8019 ADDITIVE* | | | | | | |

| | T-7 | T-8 | T-9 | T-10 |
|---|---|---|---|---|
| Methyl ethyl ketone | 45.00 | 45.00 | 45.00 | 45.00 |
| Propylene glycol | 40.32 | 40.32 | 40.32 | 25.53 |
| monomethyl ether | | | | |
| Propylene glycol | 9.50 | 9.50 | 9.50 | 9.50 |
| monomethyl ether acetate | | | | |
| SMA resin* (having an average | 4.93 | 4.93 | — | — |
| molecular weight of 2,000) | | | | |
| Alkylphenol novolac resin | — | — | 1.93 | — |
| SP-1077 (manufactured by | | | | |
| Schenectady) | | | | |
| Bisphenol A type resole resin | — | — | — | 19.72 |
| (25% propylene glycol | | | | |
| monomethyl ether solution) | | | | |
| Dye | 0.20 | 0.20 | 0.20 | 0.20 |
| | Brilliant Green | New Fuchsin | New Fuchsin | New Fuchsin |
| | (Basic dye) | (Basic dye) | (Basic dye) | (Basic dye) |
| DOW CORNING TORAY | 0.05 | 0.05 | 0.05 | 0.05 |
| 8019 ADDITIVE* | | | | |

*SMA resin: copolymer of styrene and maleic anhydride (in a molar ratio of 1:1)
*DOW CORNING TORAY 8019 ADDITIVE: silicone-based surfactant manufactured by Dow Corning Toray Co., Ltd.

### Production of Lithographic Printing Original Plate

The coating solution for lower layer prepared as shown in Table 1 was applied on the substrate obtained by the above method for producing a substrate using a roll coater, and then dried at 100° C. for 2 minutes to obtain a first image forming layer. At this time, the amount of a dried coating film was 1.5 g/m². Subsequently, the coating solution for upper layer prepared as shown in Table 2 was applied on the first image recording layer using a roll coater, and then dried at 100° C. for 2 minutes to obtain a two-layer type lithographic printing original plate. Only the image recording layer as the upper layer was removed by methyl isobutyl ketone and the amount of the dried coating film of the image recording layer as the upper layer was determined. The amount of the dried coating film of the image recording layer as the upper layer was 0.5 g/m². In such a manner, a two-layer type lithographic printing original plate was produced.

In Example 9 and Comparative Example 7, only the coating solution for lower layer prepared as shown in Table 1 was applied on the substrate to produce a single-layer type lithographic printing original plate. The thus obtained two-layer type and single-layer type lithographic printing original plates are shown in Table 3

TABLE 3
Produced Lithographic printing original plate

| | Coating solution | Coating solution |
|---|---|---|
| | for upper layer | for lower layer |
| Example 1 | B-1 | T-1 |
| Example 2 | B-1 | T-5 |
| Example 3 | B-1 | T-6 |
| Example 4 | B-2 | T-2 |
| Example 5 | B-3 | T-1 |
| Example 6 | B-4 | T-1 |
| Example 7 | B-4 | T-3 |
| Example 8 | B-4 | T-4 |
| Example 9 | B-7 | None |
| Comparative Example 1 | B-3 | T-5 |
| Comparative Example 2 | B-4 | T-6 |
| Comparative Example 3 | B-5 | T-7 |
| Comparative Example 4 | B-6 | T-8 |
| Comparative Example 5 | B-6 | T-9 |
| Comparative Example 6 | B-6 | T-10 |
| Comparative Example 7 | B-8 | None |

In Examples 1 to 8, an acid dye is added to at least one layer of the lower layer and the upper layer of the image forming layer, or both layers. In Example 9, a coating solution B-7 containing an acid dye added therein was applied to form a single layer. In Comparative Examples 1 to 6, an acid dye was not added to both the lower and upper layers of the image forming layer, and only a basic dye is added. In Comparative Example 7, a coating solution B-8 containing only a basic dye added therein was applied to form a single layer.

### Preparation of Developing Solution

According to the formulation shown in Table 4, a developing solution was prepared. The pH was 11.5 and conductivity was 1.2 mS/cm.

TABLE 4
Formulation of developing solution

| | Developing |
|---|---|
| | solution |
| Deionized water | 700 |
| Monoethanolamine | 10 |
| Diethanolamine | 30 |
| PELEX NBL (manufactured by Kao Corporation) | 200 |
| Benzyl alcohol | 60 |

### Formation of Image

The resultant lithographic printing original plate was exposed at 150 mJ/cm² using PTR4300 (manufactured by Dainippon Screen Mfg. Co., Ltd.), developed with a developing solution prepared by diluting a developing solution obtained as shown in Table 4 with water (5 times) at 30° C. for 15 seconds using an automatic processor (P-940X, manufactured by Kodak's Graphic Communications) and then subjected to gum coating with Finishing Gum PF2 (manufactured by Kodak's Graphic Communications) to obtain a lithographic printing plate.

### Baking

The resultant lithographic printing plate was washed with water and a baking counter-etching solution UT-2 (manufactured by Kodak's Graphic Communications) was applied over the entire surface of the plate using a cellulose sponge, followed by drying and further a baking treatment (at 240° C. for 10 minutes) in a baking oven.

### Evaluation Method

### (Detection of Register Mark)

“Register mark” was used as one of means for evaluation of contrast between the image area and the non-image area. In multicolor printing, it is particularly important for presswork whether or not register mark serving as a mark of registering can be detected. Register mark image was visually observed and evaluated according to the following evaluation criteria.

A: visually detectable without hindrance
B: visually detectable
C: visually undetectable

### (Contrast)

Each optical density (OD) was measured by Macbeth densitometer. Contrast was determined from a difference between the image area OD and the non-image area OD (contrast=image area OD−non-image area OD). The evaluation results are shown in Table 5. Register mark was visually detectable without hindrance for samples with contrast of 0.9 or more, while register mark was visually undetectable for samples with contrast of less than 0.3. Register mark was visually detectable when contrast is 0.3 or more, and contrast of 0.5 or more is preferable for detection of register mark.

TABLE 5
Contrast between image area and non-image area of non-baked plate and baked plate

| | Image | Image | | | | | |
|---|---|---|---|---|---|---|---|
| | portion OD of | portion OD | | Contrast of | Detection | Contrast | Detection |
| | non-baked | of baked | No-image | non-baked | of register | of baked | of register |
| | plate | plate | portion OD | plate | mark | plate | mark |
| Example 1 | 1.30 | 1.06 | 0.24 | 1.06 | A | 0.82 | B |
| Example 2 | 1.53 | 0.89 | 0.24 | 1.29 | A | 0.65 | B |
| Example 3 | 1.30 | 0.95 | 0.24 | 1.06 | A | 0.71 | B |
| Example 4 | 0.98 | 0.78 | 0.24 | 0.74 | B | 0.54 | B |
| Example 5 | 1.60 | 0.97 | 0.24 | 1.36 | A | 0.73 | B |
| Example 6 | 1.30 | 1.00 | 0.24 | 1.06 | A | 0.76 | B |
| Example 7 | 1.30 | 1.05 | 0.24 | 1.06 | A | 0.81 | B |
| Example 8 | 1.30 | 1.01 | 0.24 | 1.06 | A | 0.77 | B |
| Example 9 | 1.15 | 0.98 | 0.24 | 0.91 | A | 0.74 | B |
| Comparative | 1.66 | 0.45 | 0.24 | 1.42 | A | 0.21 | C |
| Example 1 | | | | | | | |
| Comparative | 1.20 | 0.50 | 0.24 | 0.96 | A | 0.26 | C |
| Example 2 | | | | | | | |
| Comparative | 1.06 | 0.40 | 0.24 | 0.82 | B | 0.16 | C |
| Example 3 | | | | | | | |
| Comparative | 1.64 | 0.43 | 0.24 | 1.40 | A | 0.19 | C |
| Example 4 | | | | | | | |
| Comparative | 1.64 | 0.48 | 0.24 | 1.40 | A | 0.24 | C |
| Example 5 | | | | | | | |
| Comparative | 1.64 | 0.44 | 0.24 | 1.40 | A | 0.20 | C |
| Example 6 | | | | | | | |
| Comparative | 1.15 | 0.43 | 0.24 | 0.91 | A | 0.19 | C |
| Example 7 | | | | | | | |

A non-baked plate maintains sufficient contrast between the image area and the non-image area in samples of Examples and Comparative Examples, and there was nothing wrong with detection of register mark.

In Examples 1 to 8 in which an acid dye was added to at least one of the lower layer and the upper layer of the image forming layer, and Example 9 in which an acid dye was added to a single layer, because of less fading even after baking, contrast between the image area and the non-image area was large and it was easy to detect register mark.

However, in Comparative Examples 1 to 6 in which only a basic dye was added to the lower layer and the upper layer of the image forming layer, and the baking plate of Comparative Example 7 in which only a basic dye was added to a single layer, the basic dye underwent fading after baking, and thus resulting in very low contrast between the image area and the non-image area. Therefore, it became very difficult to detect register mark.

According to the present invention, it is possible to directly making a plate from digital information of a computer, and thus making it possible to provide a plate excellent in distinction of image, which can easily detect register mark even after baking.

1. A positive lithographic printing original plate, comprising a substrate, and an image forming layer containing a water-insoluble and alkali-soluble resin and a photo-thermal conversion material, formed on the substrate, wherein
the image forming layer contains an acid dye as a colorant.

2. The positive lithographic printing original plate of claim 1, wherein the image forming layer comprises of a lower layer containing a water-insoluble and alkali-soluble resin and an upper layer containing a water-insoluble and alkali-soluble resin, formed on the substrate, the lower layer or the upper layer containing the photo-thermal conversion material, wherein
the lower layer or the upper layer contains an acid dye as a colorant.

3. The positive lithographic printing original plate according to claim 1, wherein the acid dye is selected from the group consisting of xanthene-based, indigoid-based, triphenylmethane-based, anthraquinone-based, azo-based, cyanine-based, and phthalocyanine-based dyes.

4. The positive lithographic printing original plate according to claim 1, wherein the acid dye is selected from the group consisting of Acid Red 52, Acid Red 87, Acid Red 91, Acid Red 92, Acid Red 94, and Erythrosine B (Acid Red 51).

5. The positive lithographic printing original plate according to claim 1, wherein the water-insoluble and alkali-soluble resin contains a phenol resin, and the phenol resin accounts for less than 50% by mass of the water-insoluble and alkali-soluble resin.

6. A method for making a positive lithographic printing original plate, comprising imagewise exposing the positive lithographic printing original plate according to claim 1; developing the exposed plate with a developing solution; and baking the plate.

7. The positive lithographic printing original plate according to claim 1, wherein the acid dye is present in an amount of from 0.5% to 10% by mass based on the total mass of the image forming layer.

8. The positive lithographic printing original plate according to claim 1, further comprising a basic dye in the image forming layer.

9. The method of claim 6, wherein the imagewise exposing is carried out in the near infrared to infrared region.
